(19) United States
(12) Patent Application Publication
(10) Pub. No.: US 2011/0260642 A1
(43) Pub. Date: Oct. 27, 2011

(54) INDUCTIVE CURRENT-SHARING CONTROL CIRCUIT FOR LED LAMP STRING

(75) Inventor: Ming-Ho HUANG, Wu-Ku Industrial Park (TW)

(73) Assignee: Chicony Power Technology Co., Ltd.

(21) Appl. No.: 12/764,343

(22) Filed: Apr. 21, 2010

(51) Int. Cl. H05B 41/36

(52) U.S. Cl. 315/294

(57) ABSTRACT

An inductive current-sharing control circuit for LED lamp strings includes a signal generating unit, a control unit, a current-sharing unit, a first diode, a capacitor, and a light-emitting unit. The control unit is electrically connected to the signal generating unit. The current-sharing unit is electrically connected to the first diode. The light-emitting unit is electrically connected in parallel to the capacitor. A driving voltage, which is generated by the signal generating unit, is controlled by the control unit to provide desired voltage to the light-emitting unit to provide current-sharing control, thus effectively providing a stable current source to the light-emitting unit to maintain illuminating brightness of the LED lamp strings.

### BACKGROUND OF THE INVENTION

1. Field of the Invention

The present invention relates to an inductive current-sharing control circuit, and more particularly to an inductive current-sharing control circuit which is used to provide a stable current source to LED lamp strings.

2. Description of Prior Art

An LED (light emitting diode) is a current-driving element and which has a characteristic of low-voltage unidirectional conduction. In addition, luminous flux variation of the LEDs varies with the current through the LEDs. Hence, it is essential to provide a stable current source to the LEDs, thus maintaining illuminating brightness of the LEDs.

Reference is made to FIG. 3 which is a current-voltage characteristic curve of a light emitting diode. Evidently, the characteristics of the light emitting diodes (LEDs) are non-linearity and unidirectional conduction. More particularly, a large current can flow when the LED is forward biased. In addition, luminous flux variation of the LEDs varies with the current through the LEDs. Hence, in order to effectively maintain illuminating brightness of the current-sharing control circuit, it is important to prevent producing the instant large current due to the applied voltage.

At present, the most commonly used current-sharing control circuit is composed of transistor current mirrors. However, because the transistors slightly differ in characteristics, such as the driving voltage, the current through the LED lamp strings are different, and this will result in different illuminating brightness of the LED lamp strings.

### SUMMARY OF THE INVENTION

In order to solve the above-mentioned problems, an inductive current-sharing control circuit for LED lamp strings is disclosed. The inductive current-sharing control circuit is used to provide a stable current source to maintain illuminating brightness of the LED lamp strings.

The inductive current-sharing control circuit includes a signal generating unit, a control unit, a first diode, a current-sharing unit, a capacitor, and a light-emitting unit. The signal generating unit generates a driving voltage. The control unit is electrically connected to the signal generating unit to control the driving voltage. The first diode is electrically connected to the control unit. The current-sharing unit is an inductor, and the current-sharing unit is electrically connected to the first diode. The capacitor is electrically connected to the inductor (namely, the current-sharing unit). The light-emitting unit is electrically connected in parallel to the capacitor. The control unit controls the driving voltage to provide desired voltage to the light-emitting unit to provide a current-sharing control, thus effectively providing a stable current source to the light-emitting unit to maintain illuminating brightness of the LED lamp strings.

The inductive current-sharing unit is used to achieve the current-sharing function. A very simple and economical circuit effectively provides a stable current to the light emitting diodes, thus maintaining illuminating brightness of the light emitting diodes, and more particularly increasing lifetime thereof.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a circuit diagram of an inductive current-sharing control circuit for LED lamp strings according to the present invention;

FIG. 2a is a waveform of the driving voltage which is generated from a signal generating unit;

FIG. 2b is a waveform of the current through the inductive current-sharing control circuit; and

FIG. 3 is a current-voltage characteristic curve of a light emitting diode.

### DETAILED DESCRIPTION OF THE INVENTION

Reference is made to The inductive current-sharing control circuit includes a signal generating unit 10, a control unit 20, a current-sharing unit 30, a light-emitting unit 40, a capacitor C, a first diode D1, and a second diode D2.

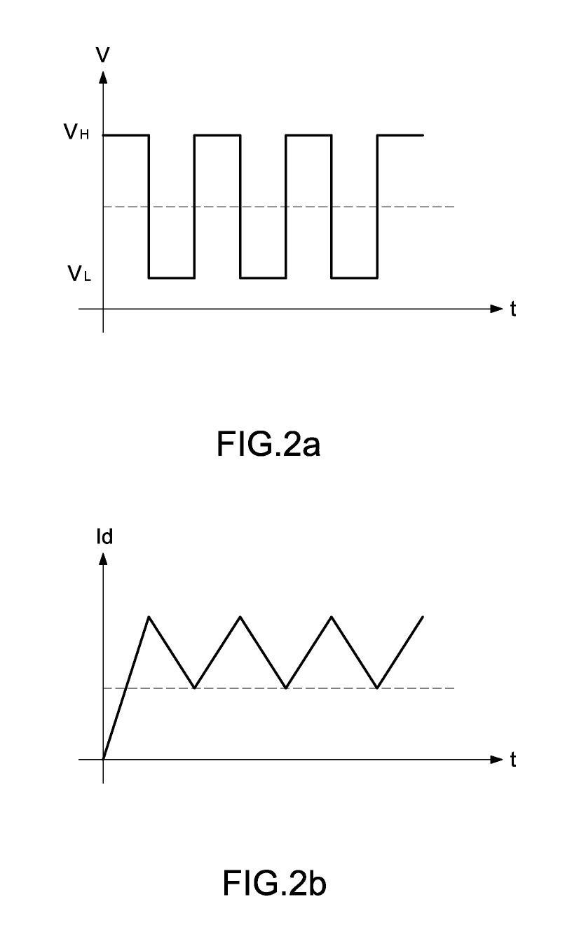

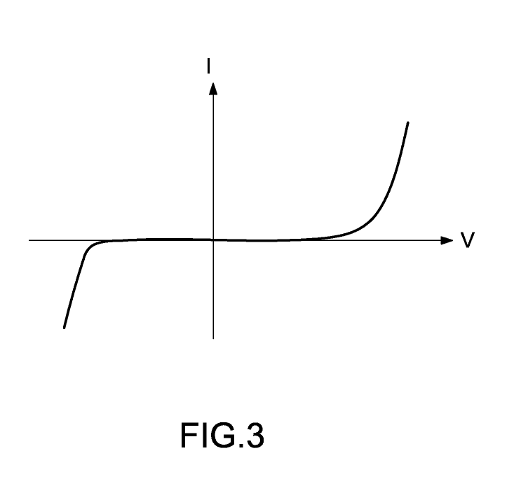

The signal generating unit 10 generates a driving voltage to drive the inductive current-sharing control circuit. In this embodiment, the driving voltage is an AC pulsating voltage (as shown in FIG. 2a). In addition, the frequency of the driving voltage can be varied through a PWM control scheme to effectively control the turn-on time and the turn-off time of the light-emitting unit 40.

The control unit 20 is electrically connected to the signal generating unit 10 to receive the driving voltage. Also, the control unit 20 provides the driving voltage to drive the light-emitting unit 40, thus controlling illuminating brightness of the light-emitting unit 40.

The current-sharing unit 30 is electrically connected to the control unit 20, and more particularly that the current-sharing unit 30 is an inductor. The current-sharing unit 30 is used to provide a stable current source to maintain stable illuminating brightness. In this embodiment, a 400-μH inductor is used to achieve the current-sharing function.

The light-emitting unit 40 is electrically connected to the current-sharing unit 30, and also that the light-emitting unit 40 has a plurality of light emitting diodes 400, which are electrically connected in series.

The capacitor C is electrically connected in parallel to the light-emitting unit 40 to filter abnormal voltage components, thus reducing influence of the abnormal pulsating voltage to the light-emitting unit 40.

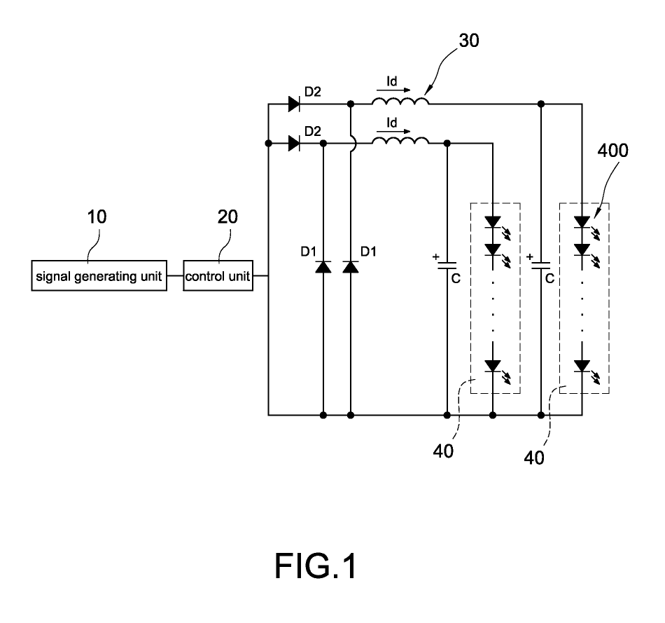

The first diode D1 is electrically connected between the control unit 20 and the current-sharing unit 30 and electrically connected in parallel to the current-sharing unit 30 and the light-emitting unit 40. More particularly, the polarity of connecting between the first diode D1 and the light emitting diode 400 is opposite. Namely, as shown in FIG. 1, a cathode of the first diode D1 is electrically connected to an anode of the light emitting diode 400.

The second diode D2 is electrically connected between the control unit 20 and the current-sharing unit 30 to restrain voltage spike caused from the signal generating unit 10, thus avoiding damaging the current-sharing unit 30 and the light emitting diode 400.

When the inductive current-sharing control circuit starts up, the signal generating unit 10 generates an AC pulsating voltage (as shown in FIG. 2a). The AC pulsating voltage has a high-level voltage VH and a low-level voltage VL. The AC pulsating voltage is sent to the control unit 20 to control illuminating brightness of the light-emitting unit 40. When the AC pulsating voltage is varied from the low-level voltage VL into the high-level voltage VH, the current, which flows through the current-sharing unit 30, rises gradually to charge the current-sharing unit 30. On the other hand, the current, which flows through the current-sharing unit 30, fall gradually to discharge the current-sharing unit 30 through the first diode D1 when the AC pulsating voltage is varied from the high-level voltage VH into the low-level voltage VL. Because the turn-on voltage of the light emitting diodes 400 is fixed, the voltage across the current-sharing unit 30 would change with the AC pulsating voltage. In addition, a current Id through the current-sharing unit 30 would also change with the AC pulsating voltage (as shown in FIG. 2b). Hence, the current through the light-emitting unit 40 is constant, thus, maintaining illuminating brightness of the light emitting diodes 400.

In conclusion, the capacitive current-sharing units 30 are used to achieve the current-sharing function. A very simple and economical circuit effectively provides a stable current to the light emitting diodes, thus maintaining illuminating brightness of the light emitting diodes, and more particularly increasing lifetime thereof.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An inductive current-sharing control circuit for LED lamp strings, comprising:
a signal generating unit generating a driving voltage;
a control unit electrically connected to the signal generating unit to control the driving voltage;
a first diode electrically connected to the control unit;
a current-sharing unit electrically connected to the first diode, wherein the current-sharing unit is an inductor;
a light-emitting unit electrically connected to the current-sharing unit;
whereby the control unit controls the driving voltage to provide desired voltage to the light-emitting unit to provide a current-sharing control according to the current-sharing unit, thus effectively providing a stable current source to the light-emitting unit to maintain illuminating brightness of the LED lamp strings.

2. The inductive current-sharing control circuit in claim 1, further comprising a second diode electrically connected between the control unit and the first diode.

3. The inductive current-sharing control circuit in claim 1, further comprising a capacitor electrically connected in parallel to the light-emitting unit.

4. The inductive current-sharing control circuit in claim 1, wherein the light-emitting unit comprises a plurality of light emitting diodes which are electrically connected in series in forward-bias direction.
